(19) United States
(12) Patent Application Publication
(10) Pub. No.: US 2009/0197170 A1
(43) Pub. Date: Aug. 6, 2009

(54) MAXIMIZATION OF ACTIVE MATERIAL TO COLLECTOR INTERFACIAL AREA

(76) Inventor: Joseph J. Viavattine, Vadnais Heights, MN (US)

Correspondence Address: MEDTRONIC, INC., 710 MEDTRONIC PARKWAY NE, MINNEAPOLIS, MN, 55432-9924, US

(21) Appl. No.: 12/024,076

(22) Filed: Jan. 31, 2008

(51) Int. Cl. H01M 4/00

(52) U.S. Cl. 429/209

(57) ABSTRACT

A current collector for a battery in an implantable medical device is presented. The current collector comprises a conductive layer which includes a first surface and a second surface. A plurality of apertures are formed in the conductive layer such that a surface area of the conductive layer with the plurality of apertures to a surface area without the plurality of apertures is greater than 0.65.

### CROSS-REFERENCE TO RELATED APPLICATION

The present application claims priority and other benefits from U.S. application Ser. No. 11/701,329 filed Jan. 31, 2007, and requested to be converted to a provisional application on Jan. 30, 2008, the disclosure of which is incorporated herein by reference in its entirety.

### FIELD OF THE INVENTION

The present invention generally relates to an electrochemical cell for an implantable medical device, and, more particularly, to a current collector used in an electrode plate for an electrochemical cell.

### BACKGROUND OF THE INVENTION

Implantable medical devices (IMDs) detect and deliver therapy for a variety of medical conditions in patients. IMDs include implantable pulse generators (IPGs) or implantable cardioverter-defibrillators (ICDs) that deliver electrical stimuli to tissue of a patient. ICDs typically comprise, inter alia, a control module, and electrochemical cells (i.e. capacitor, and a battery) that are housed in a hermetically sealed container. When therapy is required by a patient, the control module signals the battery to charge the capacitor, which in turn discharges electrical stimuli to tissue of a patient.

For patient comfort, medical devices manufacturers seek to reduce the size of IMDs. One way to reduce the size of an IMD is through reduction of one of its components such as the battery. The battery comprises a case, a liner, an electrode assembly, and electrolyte. The liner insulates the electrode assembly from the case. The electrode assembly includes electrodes, an anode and a cathode, with a separator therebetween. For a flat plate battery, an anode comprises a set of anode electrode plates with a set of tabs extending therefrom. The set of tabs are electrically connected. Each anode electrode plate includes a current collector with anode material disposed thereon. A cathode is similarly constructed. Electrolyte, introduced to the electrode assembly via a fill port in the case, is a medium that facilitates ionic transport and forms a conductive pathway between the anode and cathode.

### BRIEF DESCRIPTION OF THE DRAWINGS

The present invention will become more fully understood from the detailed description and the accompanying drawings, wherein:

FIG. 1 is a cutaway perspective view of an implantable medical device (IMD);

FIG. 2 is a cutaway perspective view of a battery (or cell) in the IMD of FIG. 1;

FIG. 3A is an enlarged view of a portion of an electrode assembly depicted in FIG. 2;

FIG. 3B is a cross-sectional view of a portion of an electrode assembly depicted in FIG. 2;

FIG. 4A is an angled cross-sectional view of a current collector in an electrode plate of the electrode assembly depicted in FIG. 3A;

FIG. 4B is an angled cross-sectional view of the electrode plate that includes the current collector depicted in FIG. 4A along with electrode material disposed thereon;

FIG. 5 is a top view of a current collector;

FIG. 6A graphically depicts a interfacial resistance ratio (IRR) to a ratio of aperture width to layer thickness of a current collector;

FIG. 6B is a top view of a grid of square apertures;

FIG. 6C is a top view of a substantially square aperture;

FIG. 7 graphically depicts a ratio of surface area created to surface area lost by creating an aperture in a current collector relative to a ratio of aperture width to layer thickness;

FIG. 8 graphically depicts a ratio of surface area created to surface area lost by creating a circular aperture in a current collector relative to a ratio of aperture diameter to layer thickness; and

FIG. 9 graphically depicts an IRR to a ratio of a circular aperture diameter to a layer thickness of a current collector.

### DETAILED DESCRIPTION

The following description of embodiments is merely exemplary in nature and is in no way intended to limit the invention, its application, or uses. For purposes of clarity, the same reference numbers are used in the drawings to identify similar elements.

The present invention is directed to a battery (also referred to as a cell) in an implantable medical device (IMD). The battery includes an electrode assembly that comprises a set of electrode plates. Each electrode plate includes a current collector with electrode material (also referred to as active material) disposed thereon. The current collector includes a conductive layer that has a first surface and a second surface with a set of apertures that extend therethrough. The inner wall of each aperture forms additional surface area. Additionally, each aperture is at least 0.01 inches (in) away from another aperture. In one embodiment, a current collector includes a surface area with apertures to a surface area without apertures of greater than 0.65. Current collectors, designed with this ratio, possess a substantially increased surface area that can be exposed to active material (i.e. cathodic material, and anodic material). Consequently, interfacial resistance between the active material (e.g. cathodic material or anodic material) and the current collector itself is reduced. Reducing interfacial resistance between the active material and the current collector allows the size of the battery to be reduced. The current collectors may be used in high reliability primary or secondary battery cells (e.g. lithium ion, etc.) or the like. The claimed invention can be applied to plate batteries, jelly roll batteries or any batteries that use a perforated current collector (butterfly, folded, etc.)

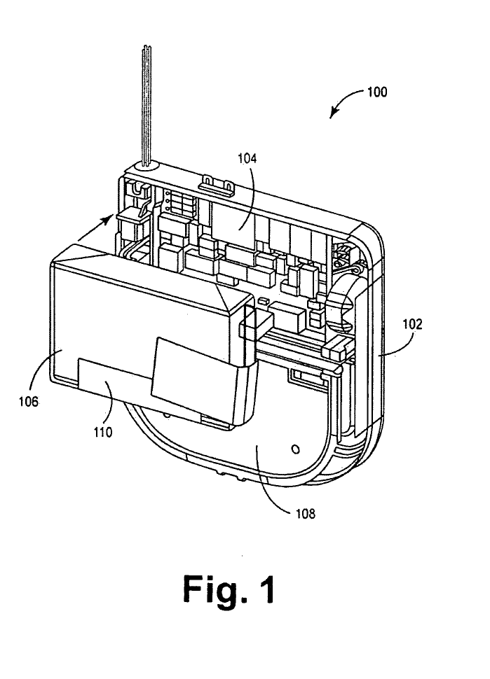

FIG. 1 depicts an IMD 100 (e.g. implantable cardioverter-defibrillators (ICDs) etc.). IMD 100 includes a case 102, a control module 104, a battery 106 (e.g. organic electrolyte battery etc.) and capacitor(s) 108. Control module 104 controls one or more sensing and/or stimulation processes from IMD 100 via leads (not shown). Battery 106 includes an insulator 110 (or liner) disposed therearound. Battery 106 charges capacitor(s) 108 and powers control module 104.

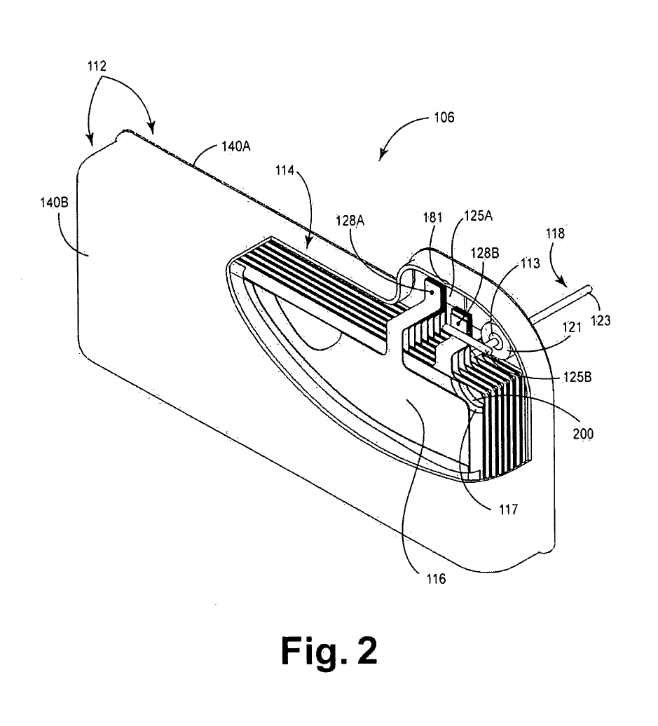

FIGS. 2 through 5 depict details of an exemplary organic electrolyte battery 106. Battery 106 includes an encasement 112, a feed-through terminal 118, a fill port 181 (partially shown), a liquid electrolyte 116, and an electrode assembly 114. Encasement 112, formed by a cover 140A and a case 140B, houses electrode assembly 114 with electrolyte 116. Feed-through assembly 118, formed by pin 123, insulator member 113, and ferrule 121, is electrically connected to jumper pin 125B. The connection between pin 123 and jumper pin 125B allows delivery of positive charge from electrode assembly 114 to electronic components outside of battery 106.

Fill port 181 (partially shown) allows introduction of liquid electrolyte 116 to electrode assembly 114. Electrolyte 116 creates an ionic path between anode 115 and cathode 119 of electrode assembly 114. Electrolyte 116 serves as a medium for migration of ions between anode 115 and cathode 119 during an electrochemical reaction with these electrodes.

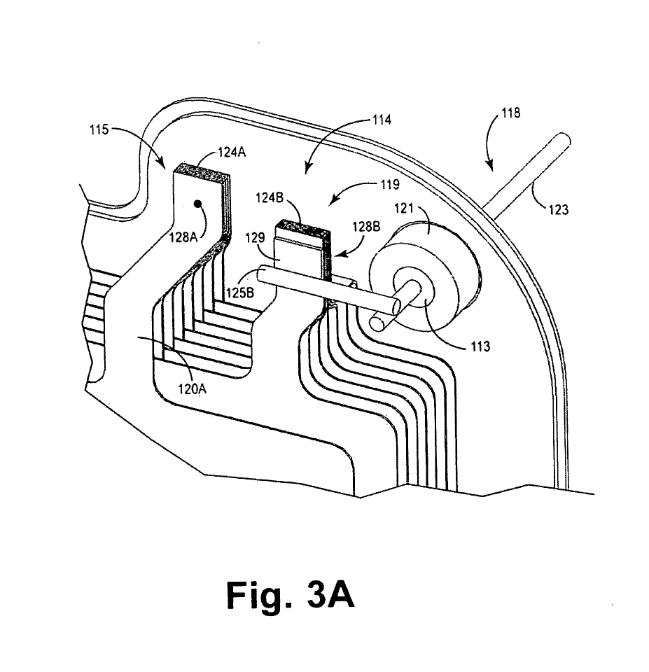

Referring to FIGS. 3A-3B, electrode assembly 114 is depicted as a stacked assembly. Anode 115 comprises a set of electrode plates 126A (i.e. anode electrode plates or electrodes) with a set of tabs 124A that are conductively coupled via a conductive coupler 128A (also referred to as an anode collector). Conductive coupler 128A may be a weld or a separate coupling member. Optionally, conductive coupler 128A is connected to an anode interconnect jumper 125A, as shown in FIG. 2.

Each electrode plate 126A includes a current collector 200 or grid, a tab 120A extending therefrom, and electrode material 144A. Tab 120A comprises conductive material (e.g. copper, etc.). Electrode material 144A includes elements from Group IA, IIA or IIIB of the periodic table of elements (e.g. lithium, sodium, potassium, etc.), alloys thereof, intermetallic compounds (e.g. Li—Si, Li—B, Li—Si—B etc.), or an alkali metal (e.g. lithium, etc.) in metallic form. As shown in FIG. 3B, a separator 117 is coupled to electrode material 144A at the top and bottom 160A-B electrode plates 126A, respectively.

Cathode 119 is constructed in a similar manner as anode 115. Cathode 119 includes a set of electrode plates 126B (i.e. cathode electrode plates or electrodes), a set of tabs 124B, and a conductive coupler 128B connecting set of tabs 124B. Conductive coupler 128B or cathode collector is connected to conductive member 129 and jumper pin 125B. Conductive member 129, shaped as a plate, comprises titanium, aluminum/titanium clad metal or other suitable materials. Jumper pin 125B is also connected to feed-through assembly 118, which allows cathode 119 to deliver positive charge to electronic components outside of battery 106. Separator 117 is coupled to each cathode electrode plate 126B.

Each cathode electrode plate 126B includes a current collector 200 or grid, electrode material 144B and a tab 120B extending therefrom. Tab 120B comprises conductive material (e.g. aluminum etc.). Electrode material 144B or cathode material includes metal oxides (e.g. vanadium oxide, silver vanadium oxide (SVO), manganese dioxide etc.), carbon monofluoride and hybrids thereof (e.g., CF_{X}+MnO₂), combination silver vanadium oxide (CSVO), lithium ion, other rechargeable chemistries, or other suitable compounds.

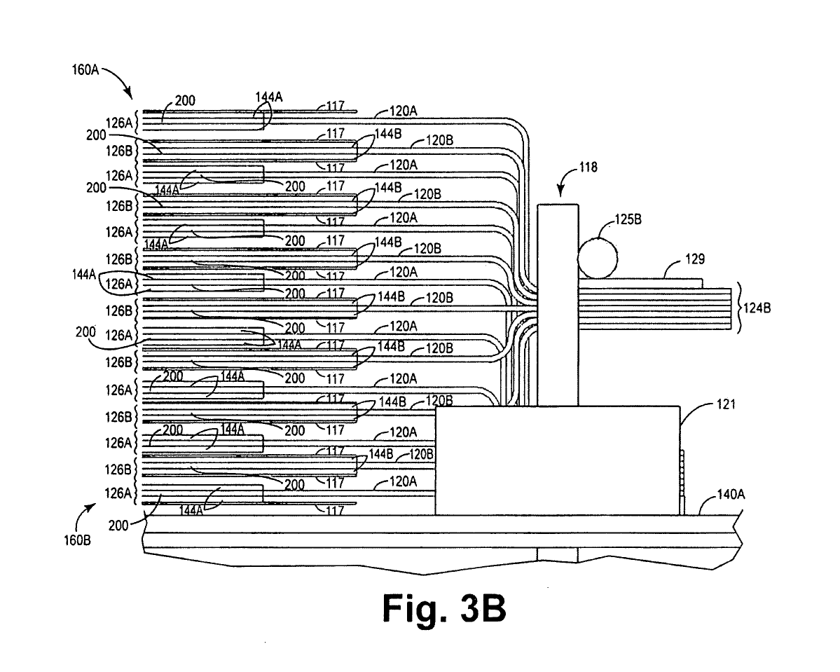

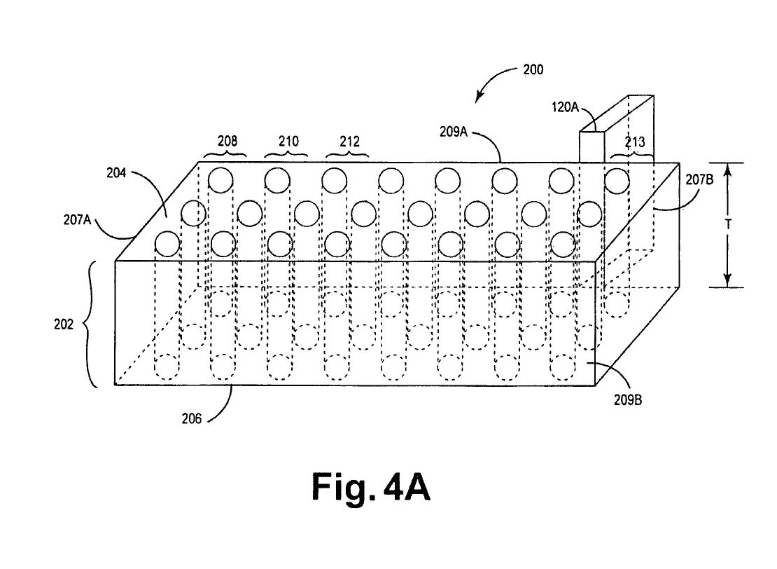

FIGS. 4A-4B and 5 depict details of current collector 200. Current collector 200 is a conductive layer 202 that includes a sides 207A, 207B, 209A, 209B, a first surface 204 and a second surface 206 with a connector tab 120A protruding therefrom. A first, second, third, and N set of apertures 208, 210, 212, 213, respectively, extend from first surface 204 through second surface 206. N set of apertures are any whole number of apertures. Conductive layer 202 may comprise a variety of conductive materials. Current collectors 202 for cathode 119 and tab 120B may be, for example, titanium, aluminum, nickel or other suitable materials. For an anode 115, current collector 200 and tab 120A comprise nickel, titanium, copper an alloy thereof or other suitable conductive material.

Referring to FIG. 4B, apertures 208, 210, 212, 213 in current collector 200 allows electrode material 262 (i.e. electrode material 144A or electrode material 144B) to electrostatically interact to form bonds 260. Bonds 260 ensure that electrode material 262 does not delaminate from current collector 200.

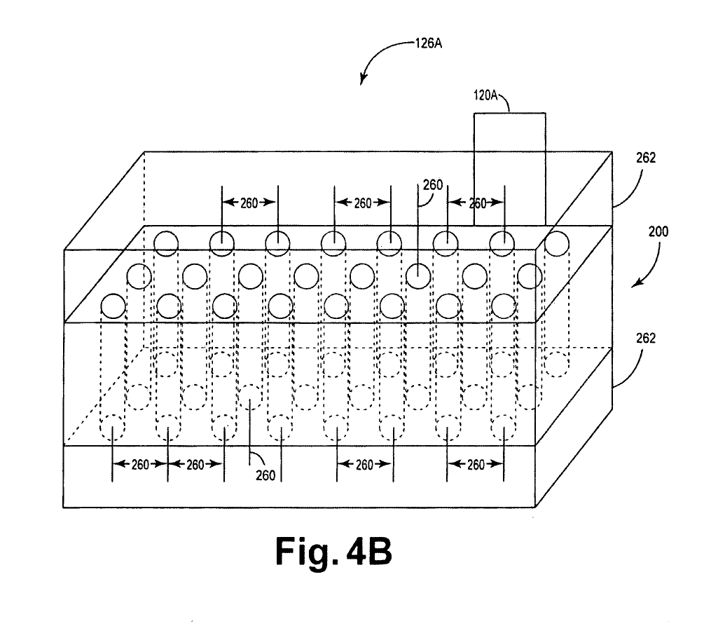

One embodiment of the claimed invention relates to current collector 300 depicted in FIG. 6B. Current collector 300 is configured to reduce the size of the battery by up to 10 percent (%). Reduction in battery size is achieved by reducing the internal resistance of the battery, which, in turn, is based upon reduction in interfacial resistance between current collector 300 and the active material (e.g. cathodic material or anodic material). Interfacial resistance is contact resistance that exists between two adjacent and different surfaces (i.e. current collector and active material). Increased interfacial area exposes more active material to the surface area of current collector 300. In one embodiment, current collector 300 includes a surface area with apertures to a surface area without apertures of greater than 0.65. This ratio is referred to as an optimized interfacial resistance ratio (IRR).

Table 1, presented below, lists various embodiments of the claimed invention. Table 1 is interpreted such that the first embodiment relates to IRR at 0.65; a second embodiment has an IRR at 0.70, and so on. The third column of Table 1 provides exemplary ranges of IRR.

TABLE 1
Individual embodiments related to IRR

| Embodiment | IRR | Range of IRR |
|---|---|---|
| 1 | 0.65 | IRR ≧ 0.65 |
| 2 | 0.7 | IRR ≧ 0.7 |
| 3 | 0.75 | IRR ≧ 0.75 |
| 4 | 0.8 | IRR ≧ 0.8 |
| 5 | 0.85 | IRR ≧ 0.85 |
| 6 | 0.90 | IRR ≧ 0.90 |
| 7 | 0.95 | IRR ≧ 0.95 |

Table 2 includes additional various ranges of IRR. For example, in the eighth embodiment, the IRR is selected to be within a range defined by the IRR being greater than 0.65 but less than 0.70. The other embodiments are interpreted in a similar manner.

TABLE 2
Individual embodiments related to IRR

| Embodiment | IRR | Range of IRR |
|---|---|---|
| 8 | 0.65 | 0.65 ≦ IRR ≦ 0.70 |
| 9 | 0.7 | 0.65 ≦ IRR ≦ 0.75 |
| 10 | 0.75 | 0.65 ≦ IRR ≦ 0.80 |
| 11 | 0.8 | 0.65 ≦ IRR ≦ 0.85 |
| 12 | 0.85 | 0.65 ≦ IRR ≦ 0.90 |
| 13 | 0.90 | 0.65 ≦ IRR ≦ 0.95 |

To achieve certain IRR, the size of the apertures depend upon balancing competing technical interests. Exemplary competing technical interests include small apertures which increase contact area while large apertures reduce inactive volume. Small apertures can possess diameters less than three times the thickness of the current collector 200. Large apertures are generally greater than eight times the thickness of the current collector 200. Typical thickness of a current collector 200 is about 0.002 inch to 0.005 inch. Contact area is defined as interfacial surface area between current collector 300 and the active material. Inactive volume is defined as material in the battery (or cell) that is not active material or usable active material (i.e. excess active material etc.). Separators and current collector 300 are exemplary elements that are considered inactive volume.

The size of individual apertures is optimized through a series of algebraic equations related to the shape of the aperture. In order to better understand aspects of the claimed invention, two examples are presented of differently shaped apertures. The first example pertains to substantially square apertures and the second example relates to circular apertures. Substantially square apertures 302 in current collector 300 are depicted in FIGS. 6B and 6C. A substantially square aperture is defined as a square aperture that includes rounded corners that are within about 90 percent (%) range of the precise shape of standard square corners.

In this embodiment, substantially square aperture 302 includes a length of a side, designated as W, and current collector 300 thickness (T) (shown in FIG. 4A). To address the rounded corners, a radius (r) is used to roughly approximate surface area associated with square aperture 302.

In this example, W and T are predetermined or preselected. Radius r is equivalent to about ¼*W; therefore, r is easily calculated. A ratio of WIT is then determined. The surface area of a substantially square aperture (SASSA) associated with current collector 300 may then be calculated in which SASSA=(0.75*W²+π*r²)*2. Thereafter, current collector 300 surface area without apertures (SAWOA) is determined in which SAWOA=2(W+T_{web})² where T_{web} is a thickness of the web, which is predetermined, and, in this example, T_{web}=10. A web is a solid portion of current collector 300 that exists between two apertures. The inner wall surface area (IWSA) determines the amount of surface area created when the square aperture 302 is formed. IWSA is defined as IWSA=2T(π*r+W). A current collector 300 surface area with apertures (SAWA) is determined in which SAWA=SAWOA−SASSA+IWSA. Thereafter, IRR is determined in which IRR=SAWA/SAWOA. Exemplary values to achieve optimized IRR include W=28 mils, T=8 mils, r=7 mils, W/T=5.6, SASSA=1,483.87 mil², SAWOA=2,888 mil², IWSA=499.91 mil², SAWA=1904.03 mil², and IRR=0.659.

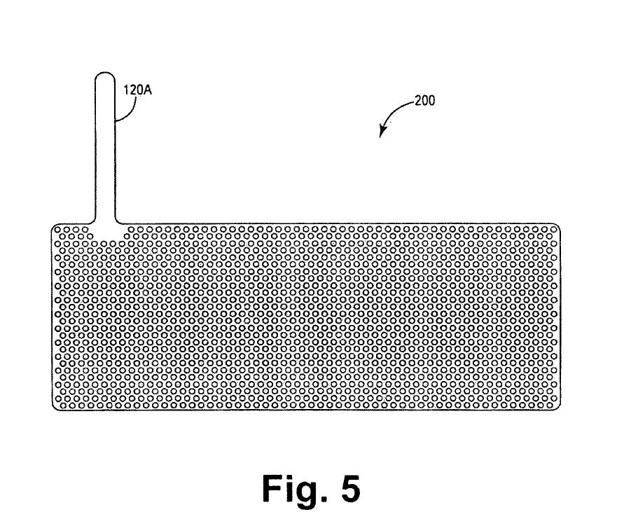

FIG. 6A graphically depicts IRR (y-axis) versus the ratio of W/T (X-axis). The optimal IRR generally occurs when 1.8≦W/T≦6. FIG. 7A depicts the ratio of surface area created to surface area lost (Y-axis) by creating the square aperture versus W/T (X-axis).

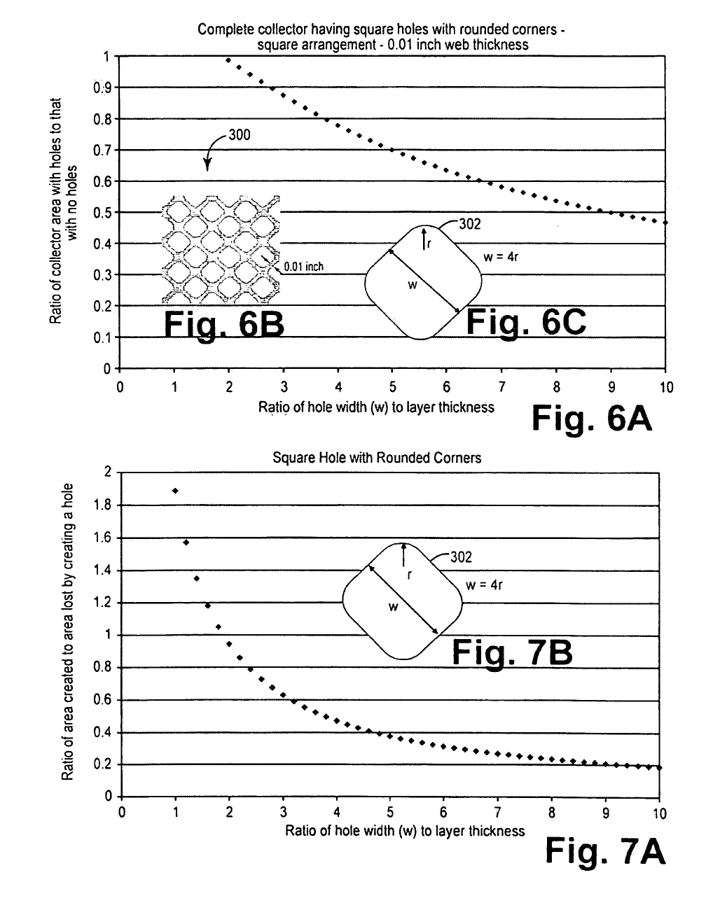

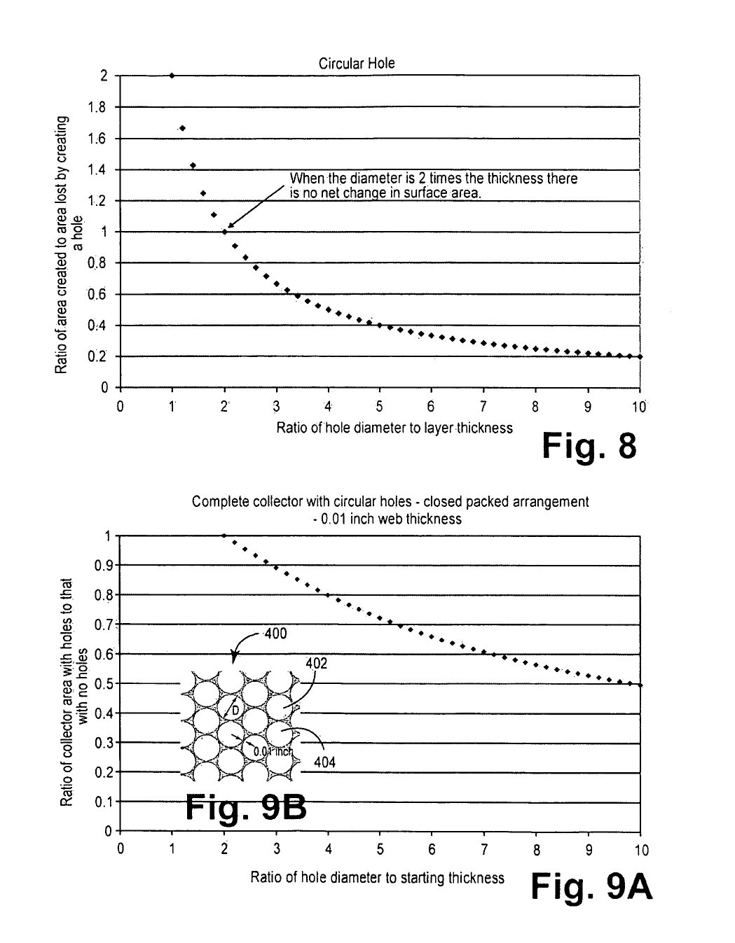

FIGS. 8-9 depict circular apertures 402 in current collector 400 that achieve an IRR greater than 0.65. In this example, aperture diameter (D) and the thickness of the current collector 400 are predetermined. A ratio of D/T is then determined. Area of circle 304 is equivalent to A=π(D²/4)*2. For circular aperture 402, the IWSA=π*D*T. The IRR is the fraction of the surface area gained/surface area lost=walled area/area of circles.

There are many other ways in which to implement an optimal IRR. For example, the IRR could be predetermined (i.e. 0.65). Thereafter, the shape of apertures 208, 210, 212, 213 could be preselected. A value for at least SAWA or SAWOA may also be preselected. The remaining variables can then be determined by designating, for example, T and then manipulating applicable geometric formulas associated with the geometric shape of the aperture. The geometric formulas could relate to at least one triangle in the aperture, substantially circular apertures, apertures shaped as a hexagon, variable shaped apertures or any other suitable shapes.

Current collectors 300, and 400 essentially include an increased amount of small apertures. In one embodiment, three to four times as many apertures are created in current collector 300 compared to conventional current collectors. For example, conventional current collectors such as those used in Medtronic's Marquis cathode current collector, include about 3740 apertures or holes. Additionally, the hole pattern includes a ratio of the hole width to the layer thickness at 8.25.

In this embodiment, closely packed apertures 208, 210, 212, 213, possess a minimum web distance of at least 0.01 inches (in) between each aperture. Specifically, first aperture 402 is at least 0.01 in from a second aperture 404. Closely packed apertures 208, 210, 212, 213, reduce battery resistance (e.g. about 30 mOhm reduction in resistance based on an ˜90 centimeter² (cm²) cell etc.). A 7% reduction in battery volume is realized through a 10% reduction in electrode area (i.e. the area of the anode and cathode).

The description of the invention is merely exemplary in nature and, thus, variations that do not depart from the gist of the invention are intended to be within the scope of the invention. Such variations are not to be regarded as a departure from the spirit and scope of the invention. For example, while several embodiments include specific dimensions, skilled artisans appreciate that these values will change depending, for example, on the shape of a particular element.

1. A current collector for a battery in an implantable medical device comprising:
a conductive layer which includes a first surface and a second surface;
a plurality of apertures formed in the conductive layer such that a surface area of the conductive layer with the plurality of apertures to a surface area without the plurality of apertures being greater than 0.65.

2. The current collector of claim 1, wherein a volumetric size of the battery being reduced by about 10%.

3. The current collector of claim 1 wherein the surface area of the conductive layer with the plurality of apertures to a surface area without the plurality of apertures being greater than 0.75.

4. The current collector of claim 1 wherein the surface area of the conductive layer with the plurality of apertures to a surface area without the plurality of apertures being greater than 0.85.

5. The current collector of claim 1 wherein the current collector includes three times an amount of apertures compared to a conventional current collector.

6. The current collector of claim 1 wherein the current collector includes four times an amount of apertures compared to a conventional current collector.

7. A battery for an implantable medical device comprising:
an anode that includes a first set of electrodes, each electrode includes a current collector and anodic active material disposed over the current collector, each current collector comprises a conductive layer which includes a first surface and a second surface, a plurality of apertures formed in the conductive layer such that a surface area of the conductive layer with the plurality of apertures to a surface area without the plurality of apertures being greater than 0.65; and
a cathode that includes a second set of electrode plates, each electrode includes a current collector and cathodic active material disposed over the current collector, each current collector comprises a conductive layer which includes a first surface and a second surface, a plurality of apertures formed in the conductive layer such that a surface area of the conductive layer with the plurality of apertures to a surface area without the plurality of apertures being greater than 0.65.

8. The battery of claim 7, wherein the first and second set of electrode contributes to about a 10% volumetric reduction in the battery.

9. The battery of claim 7 wherein the surface area of the conductive layer with the plurality of apertures to a surface area without the plurality of apertures being greater than 0.75.

10. The battery of claim 7 wherein the surface area of the conductive layer with the plurality of apertures to a surface area without the plurality of apertures being greater than 0.85.

11. The battery of claim 7 wherein the current collector includes three times an amount of apertures compared to a conventional current collector.

12. The battery of claim 7 wherein the current collector includes four times an amount of apertures compared to a conventional current collector.

13. The battery of claim 7, wherein the first and second set of electrode contributes to about a wherein a 10% volumetric reduction in the anode and the cathode.

14. A current collector for an electrochemical cell in an implantable medical device comprising:
a conductive layer which includes a first surface and a second surface;
a plurality of apertures formed in the conductive layer such that a surface area of the conductive layer with the plurality of apertures to a surface area without the plurality of apertures being greater than 0.75,
wherein the plurality of apertures is three times greater than a conventional current collector.

15. A current collector for an electrochemical cell in an implantable medical device comprising:
a conductive layer which includes a first surface and a second surface;
a plurality of apertures formed in the conductive layer such that a surface area of the conductive layer with the plurality of apertures to a surface area without the plurality of apertures being greater than 0.85,
wherein the plurality of apertures is four times greater than a conventional current collector.
